(19) United States
(12) Patent Application Publication
(10) Pub. No.: US 2024/0280319 A1
(43) Pub. Date: Aug. 22, 2024

(54) DRYING DEVICE FOR DRYING CONTAINERS CONTAINING CLEANING FLUID, CONTROL DEVICE, AND METHOD

(71) Applicant: BELVAC PRODUCTION MACHINERY, INC., Lynchburg, VA (US)

(72) Inventors: Wilko HARMS, Wittmund (DE); Ulf REINHARDT, Teutschenthal (DE)

(21) Appl. No.: 18/290,163

(22) PCT Filed: Apr. 21, 2022
(86) PCT No.: PCT/DE2022/100304

§ 371 Date: Nov. 10, 2023

(30) Foreign Application Priority Data
May 11, 2021 (DE) 10 2021 112 211.2

(51) Int. Cl. F26B 21/08; F26B 15/18; F26B 21/04; F26B 21/10; F26B 21/12

(52) U.S. Cl. CPC F26B 21/08; F26B 15/18; F26B 21/04; F26B 21/10; F26B 21/12

(57) ABSTRACT

The invention relates to a drying device (1, 100, 150) for drying containers containing cleaning fluid, particularly beverage cans, comprising a drying chamber (2, 102) for applying a drying fluid to the containers in order to remove the cleaning fluid, and an oxygen sensor arrangement (28, 128, 172) which is arranged and configured to determine a final oxygen content of the drying fluid exiting the drying chamber (2, 102).

### CROSS-REFERENCE TO RELATED APPLICATIONS

This application is a U.S. national stage of International Application No. PCT/DE2022/100304, filed Apr. 21, 2022, which claims the benefit of and priority to German Patent Application No. 10 2021 112 211.2, filed May 11, 2021, each of which are hereby incorporated by reference herein in its entirety.

### FIELD

The invention relates to a drying device for drying containers containing cleaning fluid, in particular beverage cans, a control apparatus for controlling the drying of containers containing cleaning fluid, in particular beverage cans, a manufacturing system for producing containers, in particular beverage cans, and to a method for drying containers containing cleaning fluid, in particular beverage cans.

### BACKGROUND

Drying devices for drying containers containing cleaning fluid are generally known. The production process of containers, in particular beverage cans, is characterized by a plurality of process steps. Cleaning processes are typically required between individual process steps. During the cleaning process, the containers, in particular the beverage cans, are cleaned with a cleaning fluid. In order for the subsequent process step to be carried out with the predefined parameters, the containers, in particular the beverage cans, are to be dried after the cleaning process.

To dry the containers, in particular the beverage cans, they are exposed to a drying fluid, which typically has temperatures of between 100° C. and 250° C. The drying fluid is supplied at a rate, for example, of 2 m/s to 10 m/s. The drying fluid is typically air.

The drying fluid is to be provided so that constituents of the cleaning fluid, in particular water molecules, can be absorbed. This means, for example, that the drying fluid should not be saturated until the end of a drying path.

The drying of containers, in particular beverage cans, is energy-intensive. Typically, the drying devices are operated at full load to ensure reliable drying of the containers, in particular the beverage cans. Typically, the amount of cleaning fluid introduced, for example in the form of the loading of the containers with the cleaning fluid and/or in the sense of the number of containers per unit time, is not taken into account. Therefore, the efficiency of drying devices can be improved. The existing devices and methods have different advantages, but further improvements, particularly with regard to efficiency are desirable.

It is therefore an object of the invention to provide a drying device for drying containers containing cleaning fluid, in particular beverage cans, a control device for controlling the drying of containers containing cleaning fluid, in particular beverage cans, a production system for producing containers, in particular beverage cans, as well as a method for drying containers containing cleaning fluid, in particular beverage cans, which reduce or eliminate one or more of the aforementioned disadvantages.

It is a further object of the invention to provide a solution that enables efficient drying of containers containing cleaning fluid, in particular beverage cans. It is at least an object of the invention to provide an alternative solution for drying containers containing cleaning fluid, in particular beverage cans.

This object is achieved with a drying device, a control apparatus, and a method having the features of the independent claims. Further advantageous embodiments of these aspects are disclosed in the respective dependent claims. The features individually set out in the claims and the description are mutually combinable in any technically useful manner, wherein further embodiments of the invention are revealed.

### SUMMARY

According to one embodiment, a drying device for drying containers containing cleaning fluid, in particular beverage cans, is disclosed. The drying device includes a drying chamber for applying a drying fluid to the containers for removing the cleaning fluid. The drying device further includes an oxygen sensor arrangement arranged and configured to determine a final oxygen content of the drying fluid exiting the drying chamber.

According to another embodiment, a control device for controlling the drying of containers containing cleaning fluid, in particular beverage cans, is disclosed. The control device is configured to adjust a fluid flow and/or a temperature of the drying fluid entering a drying chamber of a drying device dependent on at least one output signal of an oxygen sensor arrangement.

According to another embodiment, a method for drying containers containing cleaning fluid, in particular beverage cans is disclosed. The method includes applying a drying fluid to the containers within a drying chamber. The method further includes determining a final oxygen content of the drying fluid exiting the drying chamber.

### BRIEF DESCRIPTION OF THE DRAWINGS

Preferred embodiments will now be described by reference to the accompanying figures by way of examples. In the drawings:

FIG. 1 shows a schematic two-dimensional view of an exemplary embodiment of a drying device;

FIG. 2 shows a schematic, two-dimensional view of a further exemplary embodiment of a drying device;

FIG. 3 shows a schematic, two-dimensional view of a further exemplary embodiment of a drying device; and

FIG. 4 shows a schematic method.

In the figures, the same or substantially functionally identical and/or functionally similar elements are identified with the same reference numerals.

### DETAILED DESCRIPTION

According to a first aspect, the invention relates to a drying device for drying containers containing cleaning fluid, in particular beverage cans, comprising a drying chamber for applying a drying fluid to the containers for removing the cleaning fluid, and an oxygen sensor arrangement arranged and configured to determine a final oxygen content of the drying fluid emerging from the drying chamber.

The invention is based on the recognition that with a drying device running under full load, efficient drying of the containers is not possible. An amount of drying fluid to be introduced into the drying chamber can be regulated, for example, in that a sensor determines the quantity of cleaning fluid vapor in the drying fluid. At the end of the drying chamber, the drying fluid was to be saturated with the vapor or slightly undersaturated to allow for the highest possible efficiency, for which reason the water vapor content was directly measured. However, this approach has not resulted in a satisfactory outcome in practice.

The invention is therefore further based upon the recognition that water vapor cannot be determined directly at temperatures above 100° C. or only with a high level of effort because the gas molecules behave like an ideal gas. At below 100° C. the water is dissolved in the air. However, at above 100° C., the molecules of the air-water mixture are in equilibrium so that one additional molecule displaces another. Due to this displacement process, conventional methods for determining the saturation level are not, or are only partially, suitable.

The inventors have found that determining the saturation is enabled in a precise manner on the basis of the oxygen content within the drying chamber. The lower an oxygen content in the drying fluid, the higher the cleaning fluid content, in particular the water content. In the event that no oxygen is present, it must be assumed that only water is present. In principle, it is to be assumed that the drying fluid has the atmospheric oxygen content of 21% when entering the drying chamber. If the proportion of oxygen at the outlet of the drying chamber is now 0%, it can be assumed that the water content is 100%, and the drying fluid is therefore saturated.

The drying device comprises the drying chamber for applying the drying fluid to the containers. For this purpose, the drying chamber preferably comprises a fluid feed for feeding the drying fluid into the drying chamber. In addition, it is preferred that the drying chamber has fluid discharge for disposal or recirculation of the drying fluid from the drying chamber.

The drying fluid preferably comprises fresh fluid from the surrounding environment of the drying device and/or drawn-off fluid removed from the drying chamber. The drying device preferably has a fluid flow of the fresh fluid, i.e., the fluid entering the drying device. Further, the drying chamber preferably has a fluid flow of a waste fluid exiting the drying chamber and the drying device. In addition, the drying device can have a fluid flow of the drawn-off fluid removal from the drying chamber and fed back again to the drying chamber, preferably warmed up and/or mixed with fresh fluid prior to being fed back. The fluid flow described below is the fluid flow of the drying fluid, the fresh fluid, the drawn-off fluid, and/or the waste fluid.

The drying device can be configured to introduce and/or discharge between 5,000 cubic meters per hour and 50,000 cubic meters per hour of drying fluid into the drying chamber. The drying fluid preferably has a temperature of between 100° C. and 250° C., particularly between 150° C. and 210° C., for example 180° C. The drying fluid is preferably heated with a heating device as described below which is designed, for example, as a gas burner or with electric heating.

The drying device preferably comprises a transport unit for moving the containers in a direction of movement through the drying chamber. The transport unit is preferably configured to convey 2,000 to 4,000 containers, in particular beverage cans, per minute. Preferably, the drying chamber extends from a chamber inlet through which the containers enter the drying chamber to a chamber outlet through which the containers exit the drying chamber.

The drying fluid entering the drying chamber is preferably a mixture of a fresh fluid and a drawn-off fluid withdrawn from the drying chamber. The fresh fluid is, for example, air that is drawn from the surrounding environment of the drying device. The drawn-off air is, for example, an amount of drying fluid taken from the drying chamber at the end of a drying path, said drying fluid being already laden with the cleaning fluid. It is preferred that the drying device comprises a fluid recirculation for providing the drawn-off fluid withdrawn from the drying chamber. Further, it is preferred that the drying device comprises a mixing chamber for mixing the fresh fluid and the drawn-off fluid.

Arranged in the drying chamber, preferably adjacent to the fluid supply, are air baffles for distributing the drying fluid in the drying chamber. For example, the air baffles can be arranged within the drying chamber. Moreover, it is preferred that a fluid distribution device having two or more, in particular a plurality of apertures, is arranged adjacent to the fluid supply. In a preferred embodiment of the drying device, it is provided that it comprises a fluid collecting device for the disposal of the drying fluid laden with the cleaning fluid through the fluid discharge. The fluid collection device is in particular fluidically coupled to the fluid discharge. For example, the fluid collecting device can be or comprise a tubular member having a plurality of apertures.

It is further preferred that the drying device comprises a fluid flow apparatus, in particular a fan, arranged in a direction of fluid flow of the drying fluid upstream of the fluid supply. It is further preferred that a fluid guide plate is arranged in the direction of fluid flow upstream of the fluid flow apparatus in order to direct a fluid to the fluid flow apparatus in a targeted manner.

The oxygen sensor arrangement is arranged and configured to determine the final oxygen content. The final oxygen content is in particular the oxygen content of the drying fluid exiting the drying chamber. For example, the oxygen sensor arrangement can measure the final oxygen content at the fluid discharge. Alternatively, the oxygen sensor arrangement can also measure the final oxygen content within the drying chamber, this measurement preferably being made adjacent to the fluid discharge.

A preferred embodiment of the drying device is characterized in that it comprises a control device coupled in a signal-conducting manner to the oxygen sensor arrangement, which is set up to control a fluid flow, in particular, a fluid flow of the drying fluid, the fresh fluid, the waste fluid and/or the drawn-off fluid, and/or a temperature of the drying fluid entering the drying chamber dependent on at least one output signal of the oxygen sensor arrangement.

In particular, the fluid flow controlled by the control device is the volume entering the drying chamber per unit of time and/or the amount of drying fluid entering per unit of time. The fluid flow of the fresh fluid is, in particular, the volume of fresh fluid entering the drying device per unit time, particularly fresh air from outside the drying device, and/or the amount of fresh fluid entering the drying device per unit time.

For this purpose, the control device is preferably coupled to fluid inlet regulators and/or fluid outlet regulators, which are further described below. Furthermore, the control device is preferably coupled to a heating device in order to control the temperature of the drying fluid entering the drying chamber. The output signal of the oxygen sensor arrangement preferably characterizes an oxygen content, in particular a final oxygen content, of the drying fluid.

Controlling the fluid flow and/or the temperature, and thus indirectly the saturation of the drying fluid, enables efficient drying of the containers. In particular, an oxygen content can thus be set that represents the highest possible saturation of the drying fluid with the cleaning fluid. Thus, the drying process can be brought close to an optimum, which firstly allows safe drying of the containers and secondly reduces the consumption of resources for generating the fluid flow and/or for air heating.

In a further preferred embodiment of the drying device, it is provided that the control device is configured to determine a fluid moisture level, in particular an air humidity, of the drying fluid exiting the drying chamber, based on the final oxygen content.

By means of such a determination, the control device can adjust the fluid flow and/or the temperature of the drying fluid such that the fluid moisture level is 100% saturation or slightly thereunder, for example between 90% and 100%, 95% and 100%, 97.5% and 100%.

Another preferred further development of the drying device is characterized in that the control device is configured to increase the fluid flow and/or the temperature of the drying fluid entering the drying chamber upon exceeding a threshold value of fluid moisture. The threshold value of fluid moisture is preferably predefined. For example, the threshold value of the fluid moisture can be between 90% and 100%, between 95% and 100%, between 97.5% and 100%. If the threshold value is, for example, 100%, exceeding the threshold value would mean that the drying fluid emerging from the drying chamber is saturated and could not absorb any further cleaning fluid. Thus, there is a risk that the containers have not been completely dried.

It is also preferred that the control device is configured to reduce the fluid flow and/or the temperature of the drying fluid entering the drying chamber if the threshold value of the fluid moisture level is undershot. For example, if the threshold value is set at 95% and the drying fluid has a fluid moisture level of 90%, this means that the drying fluid is not saturated and the fluid flow is either set too high and/or the temperature is too high. An excessively high fluid flow and/or temperature result in unnecessary energy consumption, which increases the resource demand of the drying device and thus of the overall manufacturing process of the containers.

It is further preferred that the control device is configured to regulate the fluid flow and/or the temperature by means of the threshold value, in particular by means of an upper and/or a lower threshold value.

It is particularly preferred that the control device is configured so that a threshold value of the fluid moisture is not exceeded and/or undershot. In particular, it is preferred that the control device is configured so that an upper threshold value of the fluid moisture is not exceeded and/or a lower threshold value of the fluid moisture is not undershot. With regard to possible moisture values for the upper and/or lower threshold value, reference is made to the corresponding values below.

In a further preferred embodiment of the drying device, it is provided that it comprises a heating device, which is coupled in a signal-conducting manner to the control device for adjusting, in particular for increasing and/or reducing, the temperature of the drying fluid entering the drying chamber. The heating device is preferably configured to be electrically heating and/or exhaust gas-emitting, for example, as a gas burner.

A heating device, coupled to the control device in a signal-conducting manner, enables the drying fluid to be heated in a targeted manner such that the fluid moisture level and/or final oxygen content can be adjusted to maximize efficiency.

Another preferred development of the drying device is characterized in that the oxygen sensor arrangement is configured to determine an initial oxygen content of the drying fluid entering the drying chamber. The drying fluid entering the drying chamber already has a temperature of typically above 100° C., so that the above-mentioned problem of its behavior as an ideal gas arises.

In an exhaust gas-emitting heating device, for example a gas burner, water is emitted as a reaction product. As a result, a non-negligible amount of water is already contained in the drying fluid. By measuring the initial oxygen content, for example adjacent to the fluid supply, this water is already taken into account. A more accurate determination of the fluid moisture level can thus be made by a difference calculation.

According to a further preferred embodiment, it is provided that the oxygen sensor arrangement comprises a first oxygen sensor for determining the final oxygen content and/or a second oxygen sensor for determining the initial oxygen content. By means of individual oxygen sensors, the final oxygen content and/or the initial oxygen content can be determined in a targeted manner. Moreover, it is preferred that two or more first oxygen sensors and/or two or more second oxygen sensors are arranged in and/or are included by the oxygen sensor arrangement.

A further preferred embodiment of the drying device is characterized in that the oxygen sensor arrangement determines the final oxygen content and/or the initial oxygen content, in particular the first oxygen sensor determines the final oxygen content and/or the second oxygen sensor determines the initial oxygen content, directly or indirectly. An indirect determination of the final oxygen content and/or the initial oxygen content can be made, for example, via the measurement of nitrogen, since the mixing ratios of nitrogen and oxygen as well as the further constituents of air are commonly known. The first oxygen sensor and/or the second oxygen sensor is or are preferably used as a nitrogen sensor or nitrogen sensors.

Another preferred development of the drying device is characterized in that it comprises a fluid flow unit, which is coupled in a signal-conducting manner to the control device, for adjusting, in particular for increasing and/or reducing, a fluid flow. The fluid flow is, in particular, a fluid flow of the drying fluid entering the drying chamber. Thus, advantageously the efficiency of the drying process can be increased by adjusting the fluid flow so that the drying fluid is saturated or nearly saturated at the fluid discharge.

In a further preferred embodiment, the drying device comprises a fluid inlet to allow in drying fluid, particularly fresh fluid, wherein the fluid inlet comprises a fluid inlet regulator for regulating the drying fluid, particularly fresh fluid, entering the drying device through the fluid inlet. The fluid inlet regulator can be configured, for example, as an adjustable flap. The fresh fluid is preferably fresh air, located, for example, in the surroundings of the drying device. By adding fresh fluid to the drying fluid, a reduction in the fluid moisture level of the drying fluid is advantageously enabled.

In addition, it is preferred that the drying device comprises a fluid outlet for disposing of the drying fluid and/or the waste fluid from the drying chamber, wherein the fluid outlet comprises a fluid outlet regulator for regulating the drying fluid and/or the waste fluid emerging from the drying chamber. For example, the fluid outlet regulator can be configured as an adjustable flap. It is particularly preferred that the drying device is configured such that a portion of the drying fluid or the waste fluid exits the drying chamber through the fluid outlet and another portion of the drying fluid, specifically the drawn-off fluid, is returned to the drying fluid entering the drying chamber.

It is preferred that the control device is configured to control the fluid inlet regulator and the fluid outlet regulator such that the volume entering through the fluid inlet substantially corresponds to the volume exiting the fluid outlet. This ensures that as little air as possible enters the drying chamber through a chamber entry through which the containers enter the drying chamber and/or exits through a chamber outlet through which the containers exit the drying chamber.

Another further preferred development of the drying device comprises a heat exchanger arranged such that a drying fluid entering through the fluid inlet, in particular fresh fluid, is heated by means of a drying fluid exiting the drying chamber, in particular, the waste fluid. With the heat exchanger, incoming drying fluid is preheated so that less energy is required to heat the drying fluid prior to its conduction into the drying chamber.

According to a further aspect, the above-mentioned object is achieved with a control device for controlling the drying of containers containing cleaning fluid, in particular beverage cans, which is configured to adjust a fluid flow and/or a temperature of the drying fluid entering a drying chamber of a drying device, dependent on at least one output signal of an oxygen sensor arrangement. The control device is adapted, in particular, for use in a drying device described above.

The control device is particularly configured to determine a fluid moisture level, in particular an air humidity, of the drying fluid exiting the drying chamber, based on the final oxygen content and preferably, if it exceeds a threshold value of the fluid moisture level, to increase the fluid flow and/or the temperature of the drying fluid entering the drying chamber and/or, if it undershoots the threshold value of the air humidity, to reduce the fluid flow and/or temperature of the drying fluid entering the drying chamber.

In a further preferred embodiment, it is provided that the control device is configured to set an operating mode of minimum energy with a final oxygen content of less than or equal to 100%, wherein the operating mode comprises the temperature of the drying fluid, in particular at the fluid feed, the fluid flow of the drying fluid into the drying chamber, and/or the fluid flow of the waste fluid exiting the fluid outlet. The operating mode of minimum energy is characterized in that the drying device has a minimized energy consumption when this operating mode is set. The temperature of the drying fluid, the fluid flow of the drying fluid into the drying chamber and the emerging fluid flow of the waste fluid are the main variables for influencing the drying of the containers and are jointly responsible for the energy consumption of the drying device. Thus, with a setting of an operating mode of minimum energy, the drying of the containers can occur at a minimum energy consumption.

According to a further aspect, the above-mentioned object is achieved with a manufacturing system for the production of containers, in particular beverage cans, comprising a drying device according to any of the embodiments described above and/or a control device according to any of the embodiments described above.

According to a further aspect, the above-mentioned object is solved by a method for drying containers containing cleaning fluid, in particular beverage cans, comprising the steps: applying drying fluid to the containers within a drying chamber and determining a final oxygen content of the drying fluid exiting the drying chamber.

It is further preferred that the method comprises the step: determining a fluid moisture level, particularly an air humidity, of the drying fluid based on the final oxygen content. It is particularly preferred that this is done on the basis of a difference calculation. Moreover, it is preferred that the fluid moisture level is additionally determined based on an initial oxygen content of the drying fluid entering the drying chamber.

For example, the fluid moisture level can be determined as follows:

f_{H2O(O2)}=100*(1−B/A)

wherein f_{H2O (O2)} is the fluid moisture level of the drying fluid exiting the drying chamber, i.e., the waste fluid, A is the oxygen content of the fresh fluid and/or the initial oxygen content, and B is the final oxygen content of the drying fluid determined with the oxygen sensor arrangement. A can optionally be a constant, specifically the general oxygen content of the air, i.e., 21%. On use of a gas burner, A is to be treated as a variable dependent on the flue gas supplied to the drying fluid.

In a further preferred embodiment of the method, it is provided that it comprises the step of: adjusting a fluid flow and/or a temperature of the drying fluid entering the drying chamber such that the fluid moisture level of the drying fluid exiting the drying chamber exceeds and/or undershoots a threshold value of the fluid moisture level. In particular, it is preferred that an upper threshold value of the fluid moisture is not exceeded and/or a lower threshold value of fluid moisture is not undershot.

The threshold value of the fluid moisture, in particular the upper and/or lower threshold value of the fluid moisture is preferably less than or equal to 100%. Moreover, it is preferred that the upper threshold value is greater than 90%, greater than 95%, and/or greater than 97.5%. Further, it is preferred that the lower threshold value is greater than 90%, greater than 95%, and/or greater than 97.5%. As long as the fluid moisture level is less than or equal to 100%, the drying fluid is in a condensation-free condition. Thus, the containers, in particular the beverage cans, can be reliably dried.

The method and its possible further developments have features and/or method steps which make them particularly suitable for being used for a drying device and its further developments.

For further advantages, embodiments and design details of the further aspects and their possible further developments, reference is also made to the prior description of the corresponding features and further developments of the drying device.

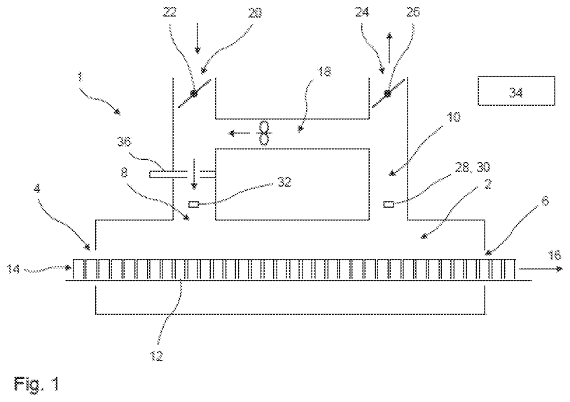

The drying device 1 shown in FIG. 1 comprises a drying chamber 2, which extends from a chamber entrance 4 to a chamber outlet 6. The beverage cans 14 are transported into the drying chamber 2 by means of a transport unit 12 through the chamber entrance 4, pass through the drying chamber 2 in a substantially horizontal direction and exit through the chamber outlet 6 again. The beverage cans 14 entering the drying chamber 2 have a cleaning fluid, for example water.

The purpose of the drying device 1 and the drying chamber 2 is, in particular, to free the beverage cans 14 of the cleaning fluid. To this end, beverage cans 14 have a drying fluid applied to them. The drying fluid enters the drying chamber 2 through a fluid supply 8. The drying fluid flows through the drying chamber 2 towards a fluid discharge 10, through which the drying fluid escapes from the drying chamber 2.

The fluid supply 8 is fluidically coupled to a fluid inlet 20 and a fluid recirculation 18. As a result, the drying fluid entering the drying chamber 2 through the fluid supply 8 can be a mixture of fresh fluid entering the fluid inlet 20 and drawn-off fluid provided by the fluid recirculation 18.

A fluid inlet regulator 22 is arranged at the fluid inlet 20 through which a fluid passes to the fluid supply 8. The fluid inlet controller 22 is coupled in a signal-conducting manner to a control device 34.

The fluid discharge 10 is fluidically coupled to the fluid recirculation 18 and a fluid outlet 24. By means of the fluid recirculation 18, a portion of the drying fluid exiting the drying chamber 2 is fed to the drying fluid entering the drying chamber 2. A portion of the drying fluid escaping from the drying chamber 2 can escape via the fluid outlet 24. The fluid outlet 24 includes a fluid outlet regulator 26 which is coupled in a signal-conducting manner to the control device 34.

The drying device 1 further comprises an oxygen sensor arrangement 28 arranged and configured to determine a final oxygen content of the drying fluid exiting the drying chamber 2. The oxygen sensor arrangement 28 includes a first oxygen sensor 30 which is arranged on the fluid discharge 10. With this arrangement, the final oxygen content of the drying fluid exiting the drying chamber 2 can advantageously be determined. Moreover, the oxygen sensor arrangement 28 comprises a second oxygen sensor 32 arranged on the fluid supply 8.

The drying device 1 further comprises a heating device 36, which in the present case is configured as an electric heating device. The control device 34 is coupled in a signal-conducting manner to the heating device 36, the fluid inlet controller 22, and the fluid outlet controller 26. By determining the final oxygen content with the oxygen sensor arrangement 28, the saturation of the drying fluid at the fluid discharge 10 can be determined. If the fluid moisture level, which can be determined with the final oxygen content, exceeds the threshold value, the control device 34 is configured to increase the fluid flow and/or the temperature of the drying fluid entering the drying chamber 2, in particular by controlling the heating device 36 and/or the inlet and/or outlet regulator 22, 26.

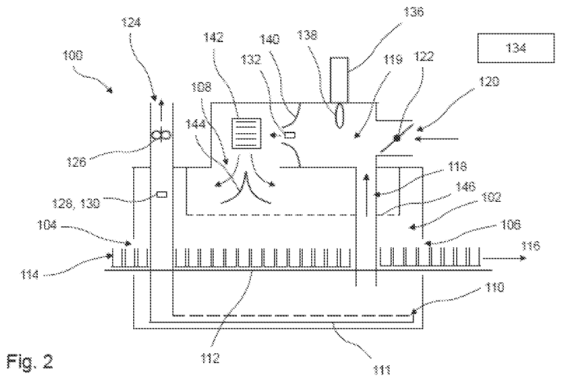

FIG. 2 shows a further design variant of a drying device 100. In a similar manner to FIG. 1, the drying device 100 has a drying chamber 102, a chamber inlet 104, a chamber outlet 106, as well as a fluid supply 108 and a fluid discharge 110. The fluid discharge 110 has a fluid exhaust collection channel 111. The fluid exhaust collection channel 111 can include, for example, a perforated sheet through which the drying fluid can enter the fluid exhaust air collection channel 111 and subsequently escape out of the fluid outlet 124 from the drying device 100. The escape of the drying fluid from the fluid outlet 124 is controlled, among other things, by means of a fluid outlet unit 126 designed as a fan.

The beverage cans 114 are moved in the transport direction 116 through the drying chamber 102 by means of a transport unit 112.

The drying device 100 further comprises a fluid recirculation unit 118. The drying fluid exiting the drying chamber 102 through the fluid recirculation unit 118 is fed by means thereof into a mixing chamber 119. The mixing chamber 119 is also fluidically coupled to the fluid inlet 120.

Thus, in the mixing chamber 119, the drying fluid recirculated from the drying chamber 2, also referred to as the drawn-off fluid, is mixed with fresh fluid by way of the fluid inlet 120. By means of the fluid inlet regulator 122 at the fluid inlet 120 and the fluid outlet unit 126 at the fluid outlet 124, the mixing ratio of fresh fluid from the surroundings of the drying device 1 and the recirculated drying fluid can be adjusted by means of the fluid recirculation unit 118.

The drying fluid located in the mixing chamber 119 can be heated by means of the heating device 136. The heating device 136 is configured as a gas burner which directs a burner flame 138 into the mixing chamber 119 to heat the drying fluid. In particular, the heating device 136 comprises a separate supply of air. The drying fluid in the mixing chamber 119 passes over fluid guide plates 140 to a fluid flow unit 142, which is designed, for example, as a fan. Via further fluid guide plates 144 adjacent to the fluid feed 108, the drying fluid is distributed within the drying chamber 2. A further distribution of the drying fluid is achieved by means of the perforated sheet 146.

The drying device 100 further comprises an oxygen sensor arrangement 128 arranged and configured to determine a final oxygen content of the drying fluid exiting the drying chamber 2. For this purpose, it comprises a first oxygen sensor 130 in the fluid discharge 110, wherein the first oxygen sensor 130 is arranged adjacent to the fluid outlet 124. In addition, the oxygen sensor arrangement 128 includes a second oxygen sensor 132 arranged between the mixing chamber 119 and the fluid supply 108.

In addition, the drying device 1 comprises a control device 134 which is coupled in a signal-conducting manner to the oxygen sensor arrangement 128. The control device 134 is configured to control the fluid flow of the drying fluid entering the drying chamber 2 and/or the temperature of this drying fluid dependent on an output signal of the oxygen sensor arrangement 128. This is done, in particular, on the basis of a calculation within the control device 134, which determines a fluid moisture content of the drying fluid exiting the drying chamber 2 on the basis of the final oxygen content.

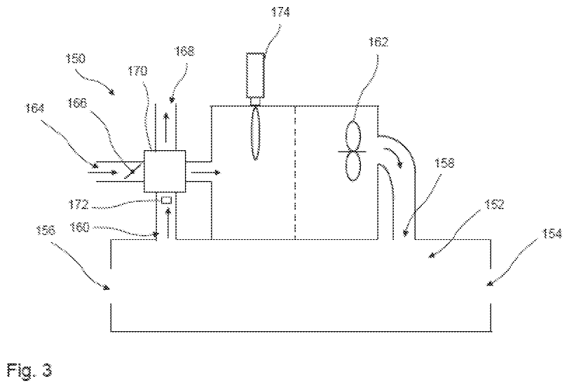

FIG. 3 shows a schematic, two-dimensional view of another exemplary embodiment of a drying device 150. The drying device 150 also includes a drying chamber 152 having a chamber inlet 154 and a chamber outlet 156, wherein drying fluid is fed into the drying chamber 152 through a fluid supply 158 and escapes from the drying chamber 152 through a fluid discharge. A fluid flow device 162 is arranged in the direction of flow upstream of the fluid feed 158.

Drying fluid, particularly fresh fluid, preferably air, flows through a fluid inlet 164 into the drying device 150. From a fluid outlet 168, the drying fluid, in particular, waste fluid, can escape from the drying device 150, in particular, from the drying chamber 152. An oxygen sensor arrangement 172 is arranged adjacently to the fluid outlet 168.

The drying device 152 comprises a heat exchanger 170 arranged such that a drying fluid entering through the fluid inlet 164 is heated by the drying fluid exiting the drying chamber 152. For this purpose, the heat exchanger 170 thermally couples a fluid outlet channel to a fluid inlet channel. The further details of the drying device 150 shown in FIGS. 1 and 2 are not shown in FIG. 3, but can be present in an analogous manner.

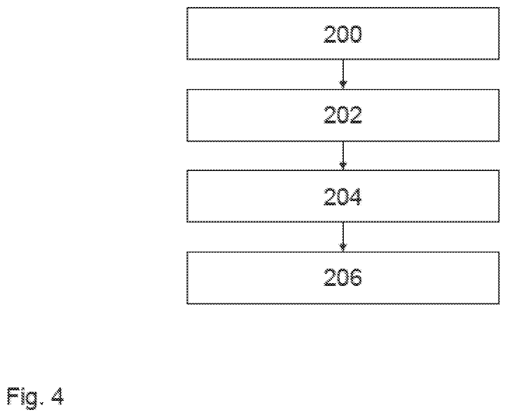

FIG. 4 shows a schematic method. In step 200, containers 14, 114 have a drying fluid applied to them within a drying chamber 2, 102. In step 202, a final oxygen content of the drying fluid exiting the drying chamber 2, 102 is determined. In step 204, a fluid moisture content is determined, particularly an air humidity, of the drying fluid based on the final oxygen content.

This can be carried out, for example, by means of a difference calculation. For example, it is known that the drying fluid entering the drying chamber 2, 102 has an oxygen content of 21%. If the drying fluid leaking out of the drying chamber has an oxygen content of 0%, this means that this drying fluid is completely saturated, i.e., it has a 100% moisture level.

In step 206, a fluid flow and/or a temperature of the drying fluid entering the drying chamber 2, 102 is set such that the fluid moisture level of the drying fluid exiting the drying chamber 2, 102 exceeds a threshold value of the fluid moisture.

Furthermore, the fluid flow and/or the temperature can be set such that the fluid moisture level of the drying fluid exiting the drying chamber is within a threshold range, for example between 95% and 100%. By means of the drying device and the corresponding method described above, efficient drying of containers, in particular of beverage cans, is enabled. This is achieved in particular by the drying fluid having a highest possible saturation, i.e., high level of air humidity. As a consequence, the temperature is set as low as possible and the fluid flow is also set as low as possible so that energy can be saved thereby.

### REFERENCE NUMERALS

1 Drying device
2 Drying chamber
4 Chamber entry
6 Chamber outlet
8 Fluid feed
10 Fluid discharge
12 Transport unit
14 Beverage cans
16 Transportation direction
18 Fluid recirculation
20 Fluid inlet
22 Fluid inlet regulator
24 Fluid outlet
26 Fluid outlet regulator
28 Oxygen sensor arrangement
30 First oxygen sensor
32 Second oxygen sensor
34 Control device
36 Heating device
100 Drying device
102 Drying chamber
104 Chamber entry
106 Chamber outlet
108 Fluid feed
110 Fluid discharge
111 Fluid exhaust air collection channel
112 Transport unit
114 Beverage cans
116 Transportation direction
118 Fluid recirculation unit
119 Mixing chamber
120 Fluid inlet
122 Fluid inlet regulator
124 Fluid outlet
126 Fluid outlet unit
128 Oxygen sensor arrangement
130 First oxygen sensor
132 Second oxygen sensor
134 Control device
136 Heating device
138 Burner flame
140 Fluid guide plates
142 Fluid flow unit
144 Fluid guide plates
146 Perforated plate
150 Drying device
152 Drying chamber
154 Chamber entry
156 Chamber outlet
158 Fluid feed
160 Fluid discharge
162 Fluid flow device
164 Fluid inlet
166 Fluid inlet regulator
168 Fluid outlet
170 Heat exchanger
172 Oxygen sensor arrangement
174 Heating device

1. A drying device for drying containers containing cleaning fluid, in particular beverage cans, comprising:
a drying chamber for applying a drying fluid to the containers for removing the cleaning fluid; and
an oxygen sensor arrangement arranged and configured to determine a final oxygen content of the drying fluid exiting the drying chamber.

2. The drying device according to claim 1, further comprising a control device coupled in a signal-conducting manner to the oxygen sensor arrangement and configured to control a fluid flow and/or a temperature of the drying fluid entering the drying chamber dependent on at least one output signal of the oxygen sensor arrangement.

3. The drying device according to claim 1, wherein the control device is configured to determine a fluid moisture level, particularly an air humidity, of the drying fluid exiting the drying chamber based on the final oxygen content.

4. The drying device according to claim 3, wherein the control device is configured,
if the threshold value of the fluid moisture is exceeded, to increase the fluid flow and/or the temperature of the drying fluid entering the drying chamber, and/or
if the threshold value of the fluid moisture is undershot, to reduce the fluid flow rate and/or the temperature of the drying fluid entering the drying chamber.

5. The drying device according to claim 1, further comprising a heating device coupled in a signal-conducting manner to the control device for adjusting, in particular for increasing, and/or reducing the temperature of the drying fluid entering the drying chamber,
wherein preferably the heating device is configured to be electrically heating and/or exhaust gas-emitting.

6. The drying device according to claim 1, wherein the oxygen sensor arrangement is configured to determine an initial oxygen content of the drying fluid entering the drying chamber.

7. The drying device according to claim 1, wherein the oxygen sensor arrangement comprises a first oxygen sensor for determining the final oxygen content and/or a second oxygen sensor for determining the initial oxygen content.

8. The drying device according to claim 1, wherein the oxygen sensor arrangement determines, directly or indirectly, the final oxygen content and/or the initial oxygen content, in particular the first oxygen sensor determines the final oxygen content and/or the second oxygen sensor determines the initial oxygen content.

9. The drying device according to claim 1, further comprising a fluid flow unit coupled in a signal-conducting manner to the control device for adjusting, in particular for increasing and/or reducing, a fluid flow.

10. The drying device according to claim 1, further comprising:
a fluid inlet to allow in drying fluid, the fluid inlet comprising a fluid inlet regulator for regulating the drying fluid entering the drying device through the fluid inlet, and/or
a fluid outlet for removing the drying fluid from the drying chamber, the fluid outlet comprising a fluid outlet regulator for regulating the drying fluid exiting through the fluid outlet from the drying chamber,
wherein preferably the control device is configured to control the fluid inlet regulator and the fluid outlet regulator such that the volume entering through the fluid inlet substantially corresponds to the volume exiting the fluid outlet.

11. A control device for controlling the drying of containers containing cleaning fluid, in particular beverage cans, which is configured to adjust a fluid flow and/or a temperature of the drying fluid entering a drying chamber of a drying device dependent on at least one output signal of an oxygen sensor arrangement.

12. The control device according to claim 11, which is configured to determine a fluid moisture level, in particular an air humidity, of the drying fluid exiting the drying chamber based on the final oxygen content, and preferably
if the threshold value of the fluid moisture is exceeded, to increase the fluid flow and/or the temperature of the drying fluid entering the drying chamber, and/or
if the threshold value of the fluid moisture is undershot, to reduce the fluid flow rate and/or the temperature of the drying fluid entering the drying chamber.

13. A manufacturing system for producing containers, particularly beverage cans, comprising a drying device according to claim 1 and/or a control device configured to adjust a fluid flow and/or a temperature of the drying fluid entering a drying chamber of a drying device dependent on at least one output signal of an oxygen sensor arrangement.

14. A method for drying containers containing cleaning fluid, in particular beverage cans, comprising:
applying a drying fluid to the containers within a drying chamber, and
determining a final oxygen content of the drying fluid exiting the drying chamber.

15. The method according to claim 14, further comprising determining a fluid moisture level, particularly an air humidity, of the drying fluid based on the final oxygen content.

16. The method according to claim 14, further comprising adjusting a fluid flow and/or a temperature of the drying fluid entering the drying chamber such that the fluid moisture level of the drying fluid exiting the drying chamber exceeds a threshold value of the fluid moisture.
